(19) United States
(12) Patent Application Publication
(10) Pub. No.: US 2012/0041855 A1
(43) Pub. Date: Feb. 16, 2012

(54) EV charging system with electric vehicle diagnostic

(76) Inventors: William D. Sterling, Pleasanton, CA (US); Chao Su, Pleasanton, CA (US); Gong-en Gu, San Ramon, CA (US)

(21) Appl. No.: 12/806,458

(22) Filed: Aug. 13, 2010

(51) Int. Cl. G06Q 30/00; H02J 7/00

(52) U.S. Cl. 705/34; 320/109; 180/65.29

(57) ABSTRACT

A charging station for recharging the battery of and electrically powered vehicle includes a diagnostic interface with the vehicle via an OBDII-type connection or the equivalent or alternatively via a wireless interface, optical interface or an electronic encoding imposed upon the charging current. Optionally a cooling system may be integrated into the charging station to enable thermal control of the energy storage system by providing heating or cooling via a second electrical circuit, or a fluid heat exchange system or by a gas heat exchange system. The charging station may produce a diagnostic test report for the EV that is sold to the vehicle operator, or the report may be provided to the vehicle operator gratis as an incentive to increase utilization of the recharging service.

### CROSS-REFERENCE TO RELATED APPLICATIONS

Not applicable.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a diagnostic and maintenance information data collection system that is integrated with an electrical recharging system for plug-in electric vehicles and the like.

2. Description of Related Art

Plug-in Hybrid Electric Vehicles (PHEV) and all-Electric Vehicles (EV), collectively referred to herein as electric vehicles (EV's), are becoming available now and will become a significant segment of vehicles on the road in the next few years. For this new market, the availability of support services is the key for the success of the business. From the point of view of owners and drivers of electric vehicles, there will be a need for easy access to battery charging services at a large number of locations in widely distributed fashion in order to extend the operating range of the vehicles. In this regard the charging stations will serve a purpose similar to gas stations that supply internal combustion vehicles, and will need to be as widely available. In addition, due to the various complex control circuits and electric parts inside the EV, it is expected that consumers will desire and benefit from accurate and easily accessible status and service information in order to obtain the maximum reliability of the EV.

The traditional way to do preventative maintenance for internal combustion engine vehicles is to schedule an appointment and leave their vehicle at a service garage for an extended time for a the diagnostic and maintenance check via a standardized On Board Diagnostics or OBDII data cable.

The basic EV coming into the market will have the capability to be charged by using a standard utility power supply, typically 110VAC/15 A or 240VAC/30 A. It may require one to six hours charging time depending on the electric storage capacity of the car and discharge level of the storage system, which is typically a battery of electrochemical cells. This longer charging time for EV provides a chance to do the EV maintenance check while the EV is receiving electrical re-charging services. Furthermore, access to the onboard diagnostic capabilities of an EV can greatly augment the recharging process, not only in assuring the safety of the recharging process but also in optimizing the recharging rate and current/voltage applied to the battery system.

For example, an EV roadster currently available that exemplifies the state of the art is equipped with a 56 KW battery that enables the vehicle to achieve and sustain freeway speeds (top speed 125 mph), and to operate for an extended distance (up to 220 miles), comparable to gasoline-powered vehicles. It may be recharged in approximately 3.5 hours using an input of 240V and 70 amps. However, this charge rate necessarily generates substantial heat in the battery, due to the internal resistance of the battery. Thus it requires a cooling system to maintain safe recharging operation (and to sustain high output power when driving the vehicle, as well). As a result, the vehicle is equipped with a cooling system for the battery, the cooling system including a liquid coolant and heat exchanger similar to an internal combustion engine. This example indicates that many EV's will require some form of battery cooling in order to achieve the fastest possible recharging, and this necessity has not received sufficient in the prior art.

The objective of this invention is to extend additional support services to the EV consumer by integrating additional vehicle service and support interfaces with the electrical vehicle recharging system. The further object is to provide an OBDII or OBDII equivalent diagnostic interface to the consumer and sell the data report to the consumer or alternatively to give the diagnostic report to the customer as an incentive to utilize the recharging service. It is another objective of this invention to deactivate the charging system whenever a fault condition is detected by the charging circuit load or a diagnostic test via the diagnostic interface. It is another objective of this invention to make available, when required, a cooling interface whereby the battery or other energy storage system can be thermally controlled during the charging operation to improve the speed or safety of the charging process. It is another objective of this invention to allow the consumer to remotely access additional support services in cases where the diagnostic interface detects a fault condition.

### BRIEF SUMMARY OF THE INVENTION

This invention generally comprises a diagnostic and maintenance information data collection system that is integrated with an electrical recharging system for plug-in electric vehicles and the like. The system includes an EV charging station which performs the recharging services for the battery of the EV. The EV charging station provides for safe connection and disconnection to the charging system.

The charging station also provides a diagnostic interface with the vehicle via an OBDII-type connection or the equivalent or alternatively via a wireless interface, optical interface or an electronic encoding imposed upon the charging current. Optionally a cooling system may be integrated into the charging station to enable thermal control of the energy storage system by providing heating or cooling via a second electrical circuit, or a fluid heat exchange system or by a gas heat exchange system.

The charging station may produce a diagnostic test report for the EV that is sold to the vehicle operator, or the report may be provided to the vehicle operator gratis as an incentive to increase utilization of the recharging service. It is significant that the charging station can utilize the diagnostic information to determine if the charging process can begin or continue safely according to the real-time sensor readings of the EV, so that recharging is carried out safely and optimally.

### BRIEF DESCRIPTION OF THE DRAWING

FIG. 1 is the concept drawing for the basic components for the Charging station.

FIG. 2 is a block diagram of the major systems of the electric vehicle and the charging station, showing their functional relationships during the recharging process.

FIG. 3 is a flow chart depicting the steps carried out in using the electric vehicle charging system of the invention to recharge the vehicle battery.

### DETAILED DESCRIPTION OF THE INVENTION

The present invention generally comprises a diagnostic and maintenance information data collection system that is integrated with an electrical recharging system for plug-in electric vehicles and the like.

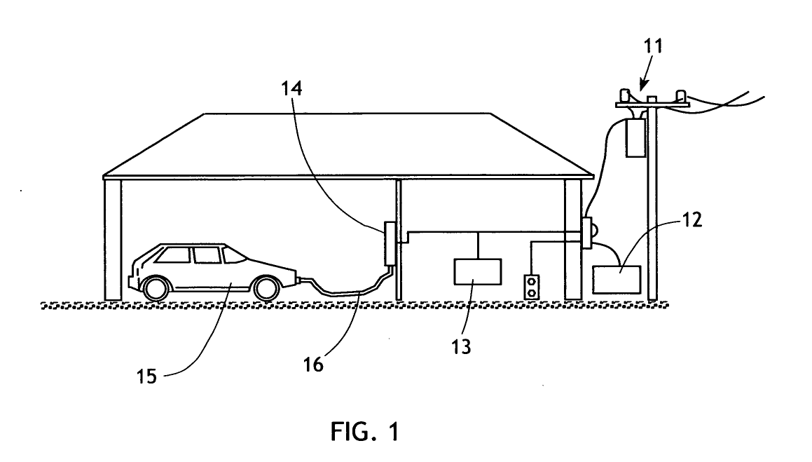

Referring to FIG. 1, which depicts the main physical components of invention, the main power supply is either from utility power grid 11, or alternative energy source 12, or the combination of both. The alternative energy source 12 can be any or all of the following sources: photovoltaic solar cell, wind power, tidal power, solar collector/steam turbine, etc. The main power supply will provide the daily power consumption for the facility, and also connect to the EV charging station 14. The charging station 14 will provide the charging service to the EV 15 via a cable set 16. The EV 15 may be an electric-only vehicle or a hybrid internal combustion\electric vehicle which consumes a gas or liquid fuel to supplement the electrical power system, or a steam\electric vehicle.

During the time EV 15 is recharging, the charging station 14 will initiate a diagnostic check with the EV 15 by communicating with the sensors and microprocessors inside the EV. The cable set 16 conveys charging current and may optionally include a data path between the charging station 14 and the EV 15 for charging control and diagnostic purposes, as described in detail below. A computer control system 13 is connected to the EV 15, either through the cable set 16 or by other wired or wireless data transmission devices known in the prior art.

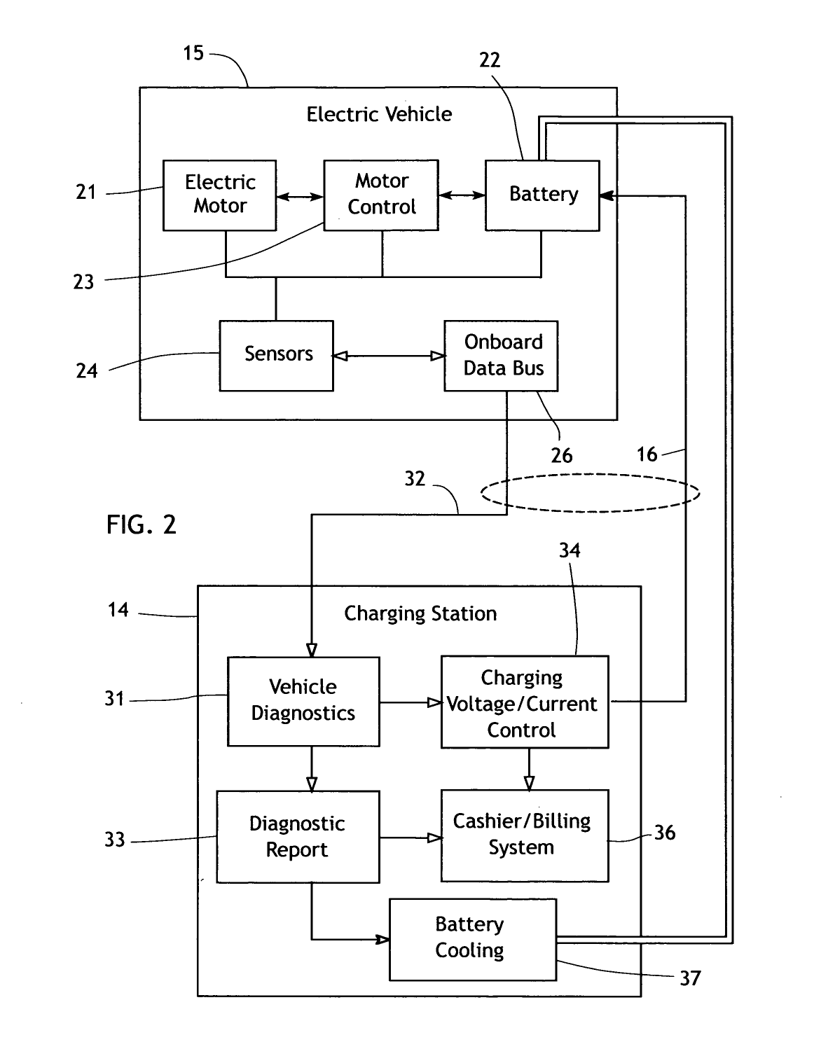

With regard to FIG. 2, the EV 15 generally includes an electric propulsion motor 21, a battery 22 of electrochemical cells, and a motor control system 23 connected therebetween to apply electrical power to the motor and propel the vehicle in response to the commands of the vehicle driver. The vehicle 15 also includes an assortment of sensors 24, including, notably, sensors that detect operational parameters such as battery temperature, battery state of charge, and the like. The sensors are connected to an onboard data bus 26, such as an ODB or ODB II or CAN known in the prior art.

The charging station 14 is provided with a vehicle diagnostics facility 31 that is connected to the onboard data bus 26 via a data link 32. The data link 32 may comprise a typical data path of any acceptable IEEE standard, including but not limited to an IEEE 802.01x or Bluetooth wireless connection, an IEEE 1394 or USB 2.0 or 3.0 cable, or the like. Alternatively, the data may be encoded and transmitted through the charging cable 16. The vehicle diagnostics facility 31 is connected to a diagnostic report unit 33 that can print a report detailing the state of the vehicle (motor, battery, subsystems, fault messages saved in the vehicle microprocessor memory, etc.) The unit 33 is connected to the charging station billing system 36, so that the report may be sold to the vehicle operator or given to the operator as a value-added service to encourage return business.

The charging station 14 also includes a charging voltage and current control 34 that is connected to the vehicle battery 22 through the cable 16. The control 34 is also connected to receive inputs from the vehicle diagnostic unit 31, and to output charging date to the billing system 36 for the purpose of tracking and summing the energy cost of the recharging service delivered to the vehicle 15. In addition, a battery cooling unit 37 is connected to the vehicle 15 and receives real-time data from the onboard data bus 26 of the vehicle through the diagnostics facilities 31 and 33. The battery cooling unit 37 may include a device to introduce air or gas coolant into the battery compartment of the vehicle 15, or an electric line to power a fan or thermoelectric device in the battery compartment. Alternatively, the battery cooling system may comprise a unit that activates the onboard battery cooling system of the vehicle 15 (for example, through the onboard data bus 26) to exchange heat with the energy storage components within the EV and maintain the storage component at a temperature to optimize the safety or charging rate of the storage component.

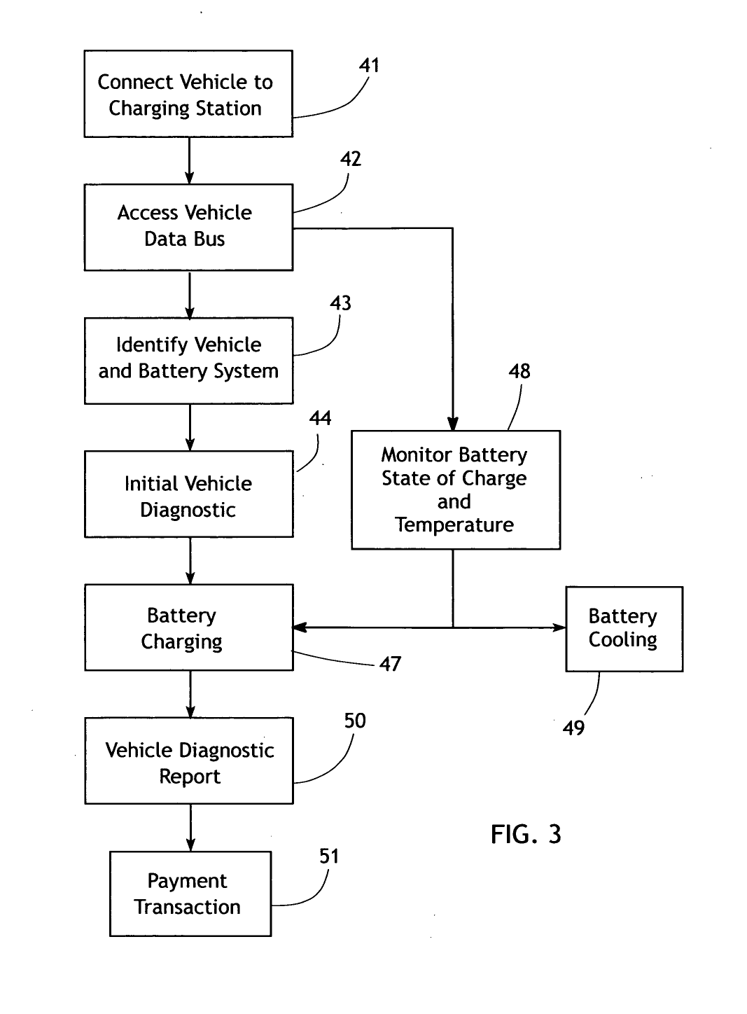

With regard to FIG. 3, there is described a method for utilizing the recharging facility depicted in FIG. 2. The first step 41 requires connecting the vehicle 15 to the charging station 14, using the cable 16 and the data transmission link 32 as described above. In step 42 the charging system 14 accesses the vehicle data bus 26, and identifies (step 43) the vehicle (type, battery system, and the like). This step is necessary to determine if the vehicle is capable of being recharged by the charging station 14. Thereafter, in step 44, the charging system performs an initial vehicle diagnostic analysis to determine, among other parameters, the state of charge of the battery 22, and to predict the amount of time required to recharge the battery fully. This step is important in apprising the vehicle owner of the expected service time, and to enable the operator of the charging station to plan for space utilization and power consumption within the station. If a peak power pricing scheme is being implemented, this step may enable the charging station operator to schedule the recharging service for optimal owner convenience (quickest charge possible), or for optimal price (delayed recharging until less expensive power supply time slot).

After the vehicle owner agrees to the recharging service (time and price), the battery charging step 47 is begun. During the recharging period, the system also monitors the battery state of charge and temperature (step 48). This step enables the battery charging system to adjust the charging voltage and current applied to the battery 22, whereby the battery temperature is held within its specifications, assuring safety during the process. In addition, the battery cooling system 37 is activated (step 49) to respond to the battery temperature and cool the battery and remove as much heat from the battery as is practical. The combination of adjusting the charging voltage and current, and activating the battery cooling system, enables the recharging station to carry out the optimal battery recharging, in terms of speed of recharging and maintaining a safe temperature within the battery 22.

In the final steps 50 and 51, the vehicle diagnostic report is produced (printed or transmitted electronically or visually), and the billing system 36 interacts with the vehicle owner to debit the owner for the charging service, through a cash/debit/credit transaction as is customary in prior art vehicle service stations. The vehicle 15 is then driven away from the charging station to make it available for the next customer. Clearly, multiple vehicles may undergo recharging simultaneously to make the most effective use of the charging station facilities.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A recharging station for an electrically powered vehicle having a propulsion motor and a battery and sensors for monitoring operational parameters of the vehicle that are connected to an onboard vehicle data bus, including:
first means for connecting said recharging station to the battery of the vehicle to apply a recharging current to the battery;
second means for connecting said recharging station to the onboard vehicle data bus;
third means for performing a diagnosis of the electric vehicle by downloading the operational parameters through said second means and analyzing data regarding the operational parameters;
fourth means connected to said third means for producing a diagnostic report of the operational parameters of the vehicle.

2. The recharging station of claim 1, further including means for conveying said diagnostic report of the operational parameters of the vehicle to an operator of the vehicle as a component of a commercial transaction involving the recharging of said battery.

3. The recharging station of claim 1, wherein one of the operational parameters comprises the temperature of the battery, and further including fifth means connected to said second means for varying said recharging current to control the temperature of the battery to be below a predetermined upper temperature limit.

4. The recharging station of claim 3, wherein said recharging station includes a battery cooling system connected to said second means and adapted to cool the battery during recharging to be below a predetermined upper temperature limit.

5. The recharging station of claim 4, wherein said battery cooling system includes means for activating a pre-existing onboard vehicle battery cooling system during recharging.

6. The recharging station of claim 4, wherein said battery cooling system includes means for applying a coolant to the vehicle battery during recharging.

7. The recharging station of claim 1, wherein said first means includes a cable extending from said recharging station to the battery.

8. The recharging station of claim 7, wherein said second means includes a data path through said cable from the onboard data bus to said recharging station.

9. The recharging station of claim 1, wherein said second means includes a wireless data path from the onboard data bus to said recharging station.

10. The recharging station of claim 2, further including means for printing said diagnostic report.

11. The recharging station of claim 2, further including means for wireless transmission of said diagnostic report to the vehicle operator.

12. The recharging station of claim 2, further including billing means for carrying out said commercial transaction in payment for said recharging of the battery.

13. A method for recharging an electrically powered vehicle having a propulsion motor and a battery and sensors for monitoring operational parameters of the vehicle that are connected to an onboard vehicle data bus, including the steps of:
connecting the vehicle battery to a recharging station with a cable capable of transmitting a recharging current to the battery;
connecting the vehicle data bus to the recharging station;
performing a vehicle identification and battery identification;
delivering recharging current through the cable to the battery;
performing a vehicle diagnostic analysis and producing a diagnostic report;
terminating the recharging current when the battery is fully charged.

14. The method for recharging an electrically powered vehicle of claim 13, further including the step of monitoring the temperature of the battery through the connection to the vehicle data bus during charging, and varying the recharging current to control the temperature of the battery to be below a predetermined upper temperature limit.

15. The method for recharging an electrically powered vehicle of claim 13, further including the step of cooling the battery during recharging to control the temperature of the battery to be below a predetermined upper temperature limit.

16. The method for recharging an electrically powered vehicle of claim 15, wherein said cooling step includes activating a pre-existing onboard vehicle battery cooling system during recharging.

17. The method for recharging an electrically powered vehicle of claim 15, wherein said cooling step includes applying a coolant to the vehicle battery during recharging.
